(19) United States
(12) Patent Application Publication
(10) Pub. No.: US 2022/0189093 A1
(43) Pub. Date: Jun. 16, 2022

(54) INTERACTION BASED ON IN-VEHICLE DIGITAL PERSONS

(71) Applicant: Shanghai SenseTime Intelligent Technology Co., Ltd., Shanghai (CN)

(72) Inventors: Qin XIAO, Shanghai (CN); Bin ZENG, Shanghai (CN); Rendong HE, Shanghai (CN); Yangping WU, Shanghai (CN); Liang XU, Shanghai (CN)

(21) Appl. No.: 17/685,563

(22) Filed: Mar. 3, 2022

Related U.S. Application Data
(63) Continuation of application No. PCT/CN2020/092582, filed on May 27, 2020.

(30) Foreign Application Priority Data
Oct. 22, 2019 (CN) 201911008048.6

(51) Int. Cl. G06T 13/40; G06V 20/59; G06V 40/16; G06F 3/01

(52) U.S. Cl. CPC G06T 13/40; G06F 3/013; G06V 40/168; G06V 20/597

(57) ABSTRACT

Methods, systems, apparatuses, and computer-readable storage media for interactions based on in-vehicle digital persons are provided. In one aspect, a method includes: acquiring a video stream of a person in a vehicle captured by a vehicle-mounted camera, processing at least one frame of image included in the video stream to obtain one or more task processing results based on at least one predetermined task, and performing, according to the one or more task processing results, at least one of displaying a digital person on a vehicle-mounted display device or controlling a digital person displayed on a vehicle-mounted display device to output interaction feedback information.

### CROSS-REFERENCE TO RELATED APPLICATION

The present application is a continuation of International Application No. PCT/CN2020/092582 filed on May 27, 2020, which claims a priority of the Chinese Patent Application No. 201911008048.6 filed on Oct. 22, 2019, all of which are incorporated herein by reference in their entireties.

### TECHNICAL FIELD

The present disclosure relates to the field of augmented reality, and in particular, to interaction methods and apparatuses based on an in-vehicle digital person, and storage media.

### BACKGROUND

At present, a robot can be placed in a vehicle, and after a person entered the vehicle, the robot can interact with the person in the vehicle. However, interaction modes between the robot and the person in the vehicle are relatively fixed, and lack humanity.

### SUMMARY

The present disclosure provides interaction methods and apparatuses based on an in-vehicle digital person, and storage media.

According to a first aspect of embodiments of the present disclosure, an interaction method based on an in-vehicle digital person is provided. The interaction method includes: acquiring a video stream of a person in a vehicle captured by a vehicle-mounted camera; processing, based on at least one predetermined task, at least one frame of image included in the video stream to obtain one or more task processing results; performing, according to the one or more task processing results, at least one of displaying a digital person on a vehicle-mounted display device or controlling a digital person displayed on a vehicle-mounted display device to output interaction feedback information.

According to a second aspect of the embodiments of the present disclosure, a non-transitory computer readable storage medium coupled to at least one processor having machine-executable instructions stored thereon is provided. When executed by the at least one processor, the machine-executable instructions causes the at least one processor to perform the interaction method based on an in-vehicle digital person according to the first aspect.

According to a third aspect of the embodiments of the present disclosure, an interaction apparatus based on an in-vehicle digital person is provided. The apparatus includes: at least one processor; and one or more memories coupled to the at least one processor and storing programming instructions for execution by the at least one processor to perform the interaction method based on an in-vehicle digital person according to the first aspect.

The foregoing and other embodiments can each optionally include one or more of the following features, alone or in combination.

In some embodiments, the at least one predetermined task includes at least one of face detection, gaze detection, watch area detection, face identification, body detection, gesture detection, face attribute detection, emotional state detection, fatigue state detection, distracted state detection, or dangerous motion detection.

In some embodiments, the person in the vehicle includes at least one of a driver or a passenger.

In some embodiments, the interaction feedback information includes at least one of voice feedback information, expression feedback information, or motion feedback information.

In some embodiments, controlling the digital person displayed on the vehicle-mounted display device to output the interaction feedback information includes: acquiring mapping relationships between the task processing results and interaction feedback instructions; determining the interaction feedback instructions corresponding to the task processing results according to the mapping relationships; and controlling the digital person to output the interaction feedback information corresponding to the interaction feedback instructions.

In some embodiments, the at least one predetermined task includes face identification, where the one or more task processing results include a face identification result, and where displaying the digital person on the vehicle-mounted display device includes one of: in response to determining that a first digital person corresponding to the face identification result is stored in the vehicle-mounted display device, displaying the first digital person on the vehicle-mounted display device; or in response to determining that a first digital person corresponding to the face identification result is not stored in the vehicle-mounted display device, displaying a second digital person on the vehicle-mounted display device or outputting prompt information for generating the first digital person corresponding to the face identification result.

In some embodiments, outputting the prompt information for generating the first digital person corresponding to the face identification result includes: outputting image capture prompt information of a face image on the vehicle-mounted display device; performing a face attribute analysis on a face image of the person in the vehicle, which is acquired by the vehicle-mounted camera in response to the image capture prompt information, to obtain a target face attribute parameter included in the face image; determining a target digital person image template corresponding to the target face attribute parameter according to pre-stored correspondences between face attribute parameters and digital person image templates; and generating the first digital person matching the person in the vehicle according to the target digital person image template.

In some embodiments, generating the first digital person matching the person in the vehicle according to the target digital person image template includes: storing the target digital person image template as the first digital person matching the person in the vehicle.

In some embodiments, generating the first digital person matching the person in the vehicle according to the target digital person image template includes: acquiring adjustment information of the target digital person image template; adjusting the target digital person image template according to the adjustment information; and storing the adjusted target digital person image template as the first digital person matching the person in the vehicle.

In some embodiments, the at least one predetermined task includes gaze detection, where the one or more task processing results include a gaze direction detection result, and where the interaction method includes: in response to the gaze direction detection result indicating that a gaze from the person in the vehicle points to the vehicle-mounted display device, performing at least one of: displaying the digital person on the vehicle-mounted display device or controlling the digital person displayed on the vehicle-mounted display device to output the interaction feedback information.

In some embodiments, the at least one predetermined task includes watch area detection, where the one or more task processing results include a watch area detection result, and where the interaction method includes: in response to the watch area detection result indicating that a watch area of the person in the vehicle at least partially overlaps with an area for arranging the vehicle-mounted display device, performing at least one of: displaying the digital person on the vehicle-mounted display device or controlling the digital person displayed on the vehicle-mounted display device to output the interaction feedback information.

In some embodiments, the person in the vehicle includes a driver, and where processing, based on the at least one predetermined task, the at least one frame of image included in the video stream to obtain the one or more task processing results includes: according to at least one frame of face image of the driver located in a driving area included in the video stream, determining a category of a watch area of the driver in each of the at least one frame of face image of the driver.

In some embodiments, the category of the watch area is obtained by pre-dividing space areas of the vehicle, and where the category of the watch area includes one of: a left front windshield area, a right front windshield area, a dashboard area, an interior rearview mirror area, a center console area, a left rearview mirror area, a right rearview mirror area, a visor area, a shift lever area, an area below a steering wheel, a co-driver area, a glove compartment area in front of a co-driver, or a vehicle-mounted display area.

In some embodiments, according to the at least one frame of face image of the driver located in the driving area included in the video stream, determining the category of the watch area of the driver in each of the at least one frame of face image of the driver includes: for each of the at least one frame of face image of the driver, performing at least one of gaze or head posture detection on the frame of face image of the driver; and for each frame of face image in the video stream, determining the category of the watch area of the driver in the frame of face image of the driver according to a result of the at least one of the gaze or the head posture detection of the frame of face image of the driver.

In some embodiments, according to the at least one frame of face image of the driver located in the driving area included in the video stream, determining the category of the watch area of the driver in each of the at least one frame of face image of the driver includes: inputting the at least one frame of face image into a neural network to output the category of the watch area of the driver in each of the at least one frame of face image through the neural network, where the neural network is pre-trained by one of: using a face image set, each face image in the face image including watch area category label information in the face image, the watch area category label information indicating the category of the watch area of the driver in the face image, or using a face image set and being based on eye images intercepted from each face image in the face image set.

In some embodiments, the neural network is pre-trained by: for a face image including the watch area category label information from the face image set, intercepting an eye image of at least one eye in the face image, where the at least one eye includes at least one of a left eye or a right eye, respectively extracting a first feature of the face image and a second feature of the eye image of the at least one eye, fusing the first feature and the second feature to obtain a third feature, determining a watch area category detection result of the face image according to the third feature by using the neural network, and adjusting network parameters of the neural network according to a difference between the watch area category detection result and the watch area category label information.

In some embodiments, the interaction method further includes: generating vehicle control instructions corresponding to the interaction feedback information; and controlling target vehicle-mounted devices corresponding to the vehicle control instructions to perform operations indicated by the vehicle control instructions.

In some embodiments, the interaction feedback information includes information contents for alleviating a fatigue or distraction degree of the person in the vehicle, and where generating the vehicle control instructions corresponding to the interaction feedback information includes at least one of: generating a first vehicle control instruction that triggers a target vehicle-mounted device, where the target vehicle-mounted device includes a vehicle-mounted device that alleviates the fatigue or distraction degree of the person in the vehicle through at least one of taste, smell, or hearing; or generating a second vehicle control instruction that triggers driver assistance.

In some embodiments, the interaction feedback information includes confirmation contents for a gesture detection result, and where generating the vehicle control instructions corresponding to the interaction feedback information includes: according to mapping relationships between gestures and the vehicle control instructions, generating a vehicle control instruction corresponding to a gesture indicated by the gesture detection result.

In some embodiments, the interaction method includes: acquiring audio information of the person in the vehicle captured by a vehicle-mounted voice capturing device; performing voice identification on the audio information to obtain a voice identification result; and according to the voice identification result and the one or more task processing results, performing the at least one of displaying the digital person on the vehicle-mounted display device or controlling the digital person displayed on the vehicle-mounted display device to output the interaction feedback information.

In the embodiments of the present disclosure, by analyzing images in a video stream of a person in a vehicle, task processing results of predetermined task processing on the video stream are obtained. According to the task processing results, display or interaction feedback of a virtual digital person is automatically triggered, so that a human-computer interaction manner is more in line with human interaction habits, and an interaction process is more natural, which enables the person in the vehicle to feel the warmth of human-computer interaction, and enhances the riding pleasure, comfort and companion, and helps to reduce the driving safety risks.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more embodiments of the present disclosure are set forth in the accompanying drawings and the description below. Other features and advantages of this specification will be apparent from the description and drawings, and from the claims.

### BRIEF DESCRIPTION OF THE DRAWINGS

FIG. 1 is a flowchart illustrating an interaction method based on an in-vehicle digital person according to one or more embodiments of the present disclosure.

FIG. 2 is a flowchart illustrating step 103 of FIG. 1 according to one or more embodiments of the present disclosure.

FIG. 3 is a flowchart illustrating an interaction method based on an in-vehicle digital person according to another exemplary embodiment of the present disclosure.

FIG. 4 is a flowchart illustrating step 107 of FIG. 3 according to one or more embodiments of the present disclosure.

FIGS. 5A to 5B are schematic diagrams illustrating a scene in which a target digital person image template is adjusted according to one or more embodiments of the present disclosure.

FIG. 6 is a schematic diagram illustrating multiple categories of defined watch areas obtained by spatial division of a vehicle according to one or more embodiments of the present disclosure.

FIG. 7 is a flowchart illustrating step 103-8 of FIG. 2 according to one or more embodiments of the present disclosure.

FIG. 8 is a flowchart illustrating a method for training a neural network for detecting a watch area category according to one or more embodiments of the present disclosure.

FIG. 9 is a flowchart illustrating a method for training a neural network for detecting a watch area category according to another exemplary embodiment of the present disclosure.

FIG. 10 is a flowchart illustrating an interaction method based on an in-vehicle digital person according to another exemplary embodiment of the present disclosure.

FIGS. 11A to 11B are schematic diagrams illustrating gestures according to one or more embodiments of the present disclosure.

FIGS. 12A to 12C are schematic diagrams illustrating an interaction scene based on an in-vehicle digital person according to one or more embodiments of the present disclosure.

FIG. 13A is a flowchart illustrating an interaction method based on an in-vehicle digital person according to another exemplary embodiment of the present disclosure;

FIG. 13B is a flowchart illustrating an interaction method based on an in-vehicle digital person according to another exemplary embodiment of the present disclosure.

FIG. 14 is a block diagram illustrating an interaction apparatus based on an in-vehicle digital person according to one or more embodiments of the present disclosure.

FIG. 15 is a schematic diagram illustrating a hardware structure of an interaction apparatus based on an in-vehicle digital person according to one or more embodiments of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein refers to and includes any and all possible combinations of one or more of the associated listed items.

It is to be understood that, although terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, second information may also be referred as first information. Depending on the context, the word “if” as used herein may be interpreted as “when” or “upon” or “in response to determining”.

An embodiment of the present disclosure provides an interaction method based on an in-vehicle digital person, which can be used for drivable machine equipment, such as smart vehicles, and smart vehicle cabins that simulate vehicle driving.

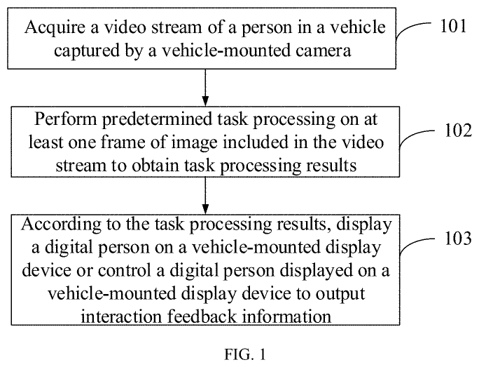

FIG. 1 shows an interaction method based on an in-vehicle digital person according to an exemplary embodiment. The method includes following steps 101 to 103.

At step 101, a video stream of a person in a vehicle captured by a vehicle-mounted camera is acquired.

In the embodiments of the present disclosure, the vehicle-mounted camera can be arranged on a center console, a front windshield, or any other positions where the person in the vehicle can be photographed. The person in the vehicle include a driver and/or a passenger. Through the vehicle-mounted camera, the video stream of the person in the vehicle can be captured in real time.

At step 102, predetermined task processing is performed on at least one frame of image included in the video stream to obtain one or more task processing results.

At step 103, according to the task processing results, a digital person is displayed on a vehicle-mounted display device or a digital person displayed on a vehicle-mounted display device is controlled to output interaction feedback information.

In the embodiments of the present disclosure, the digital person may be a virtual image generated by software, and the digital person may be displayed on the vehicle-mounted display device, such as a central control display screen or a vehicle-mounted tablet device. The interaction feedback information output by the digital person includes at least one of voice feedback information, expression feedback information, or motion feedback information.

In the above embodiment, by analyzing images in the video stream of the person in the vehicle, the task processing results of the predetermined task processing on the video stream are obtained. According to the task processing results, display or interaction feedback of a virtual digital person is automatically triggered, so that a human-computer interaction manner is more in line with human interaction habits, and an interaction process is more natural, which enables the person in the vehicle to feel the warmth of human-computer interaction, and enhances the riding pleasure, comfort and companion, and helps to reduce the driving safety risks.

In some embodiments, predetermined tasks that need to be processed on the video stream may include, but are not limited to, at least one of face detection, gaze detection, watch area detection, face identification, body detection, gesture detection, face attribute detection, emotional state detection, fatigue state detection, distracted state detection, or dangerous motion detection. According to the task processing results of the predetermined tasks, the human-computer interaction manner based on the in-vehicle digital person is determined. For example, according to the task processing results, it is determined whether it is necessary to trigger the display of the digital person on the vehicle-mounted display device, or to control the digital person displayed on the vehicle-mounted display device to output corresponding interaction feedback information or the like.

In an example, face detection is performed on at least one frame of image included in a video stream to detect whether face parts are included in a vehicle to obtain a face detection result of whether the at least one frame of image included in the video stream includes the face parts, and subsequently according to the face detection result, it can be determined whether there is a person entering or leaving the vehicle, then it can be determined whether to display a digital person or to control a digital person to output corresponding interaction feedback information. For example, when the face detection result indicates that the face parts have just been detected, the digital person can be automatically displayed on the vehicle-mounted display device, or the digital person can be controlled to output greetings, such as “hello”, or other voices, expressions, or motions.

In another example, gaze detection or watch area detection is performed on at least one frame of image included in a video stream to obtain a gaze watch direction detection result or a watch area detection result of a person in a vehicle. Subsequently, according to the gaze watch direction detection result or the watch area detection result, it can be determined whether to display a digital person or control a digital person to output interaction feedback information. For example, when a gaze watch direction of the person in the vehicle points to a vehicle-mounted display device, the digital person can be displayed. When a watch area of the person in the vehicle at least partially overlaps with an area for arranging the vehicle-mounted display device, the digital person is displayed. When the gaze watch direction of the person in the vehicle points to the vehicle-mounted display device again, or the watch area of the person in the vehicle at least partially overlaps with the area for arranging the vehicle-mounted display device again, the digital person can be allowed to output “what can I do for you”, or other voices, expressions, or motions.

In another example, face identification is performed on at least one frame of image included in a video stream to obtain a face identification result, and subsequently a digital person corresponding to the face identification result can be displayed. For example, if the face identification result matches a pre-stored face part of San ZHANG, a digital person corresponding to San ZHANG can be displayed on the vehicle-mounted display device. If the face identification result matches a pre-stored face part of Si LI, a digital person corresponding to Si LI can be displayed on the vehicle-mounted display device. Digital persons corresponding to San ZHANG and Si LI can be different, thereby enriching the images of the digital persons, enhancing the riding pleasure, comfort and companion, and allowing the person in the vehicle to feel the warmth of human-computer interaction.

For another example, digital persons can output voice feedback information, such as “hello, San ZHANG or Si LI”, or by outputting some expressions or motions preset for San ZHANG.

In another example, body detection is performed on at least one frame of image included in a video stream, and includes, but is not limited to, sitting postures, hand and/or leg motions, head positions, etc. to obtain a body detection result. Subsequently, according to the body detection result, a digital person can be displayed or controlled to output interaction feedback information. For example, if the body detection result is that a sitting posture is suitable for driving, the digital person can be displayed. If the body detection result is that the sitting posture is not suitable for driving, the digital person can be controlled to output “relax to sit comfortably”, or other voices, expressions, or motions.

In another example, gesture detection is performed on at least one frame of image included in a video stream to obtain a gesture detection result, so that according to the gesture detection result, it can be determined what gesture a person in a vehicle input. For example, a person in the vehicle inputs an “ok” gesture or a “great” gesture. Subsequently, according to the input gesture, a digital person can be displayed or controlled to output interaction feedback information corresponding to the gesture. For example, if the gesture detection result is that the person in the vehicle inputs a greeting gesture, the digital person can be displayed. Or, if the gesture detection result is that the person in the vehicle inputs the “great” gesture, the digital person can be controlled to output “thanks for the compliment”, or other voices, expressions, or motions.

In another example, face attribute detection is performed on at least one frame of image included in a video stream. Face attributes include, but are not limited to, whether there are double eyelids, whether glasses are worn, whether there is a beard, a beard position, ear shapes, a lip shape, a face shape, a hairstyle, etc. to obtain a face attribute detection result of a person in a vehicle. Subsequently, according to the face attribute detection result, a digital person can be displayed or controlled to output interaction feedback information corresponding to the face attribute detection result. For example, the face attribute detection result indicates that sunglasses are worn, the digital person can output interaction feedback information such as “the sunglasses are nice”, “today's hairstyle is good”, “you are so beautiful today”, or other voices, expressions, or motions.

In another example, emotional state detection is performed on at least one frame of image included in a video stream to obtain an emotional state detection result. The emotional state detection result directly reflects emotion of a person in a vehicle, such as happiness, anger, and sadness. Subsequently, according to the emotion of the person in the vehicle, a digital person can be displayed. For example, when a person in the vehicle is smiling, the digital person can be displayed. Or, according to the emotion of the person in the vehicle, the digital person can be controlled to output corresponding interaction feedback information that alleviates the emotions. For example, when the person in the vehicle is angry, the digital person can be allowed to output “don't be angry, and let me tell you a joke”, “is there anything happy or unhappy today?”, or other voices, expressions, or motions.

In another example, fatigue state analysis is performed on at least one frame of image included in a video stream to obtain a fatigue degree detection result, such as no fatigue, slight fatigue, or severe fatigue. According to fatigue degrees, a digital person can be allowed to output corresponding interaction feedback information. For example, if a fatigue degree belongs to the slight fatigue, the digital person can output “let me sing a song for you”, “do you need to have a break”, or other voices, expressions, or motions to alleviate fatigue.

In another example, when distracted state detection is performed on at least one frame of image included in a video stream, a distracted state detection result can be obtained. For example, by detecting whether a person in a vehicle is watching ahead on the at least one frame of image, it can be determined whether the person in the vehicle is currently distracted. According to the distracted state detection result, a digital person can be controlled to output “attention, please”, “well done, please keep on”, or other voices, expressions, or motions.

In another example, dangerous motion detection can be performed on at least one frame of image included in a video stream to obtain a detection result of whether a person in a vehicle is currently performing dangerous motion. For example, all motions that two hands of a driver are not put on a steering wheel, the driver is not watching ahead, a part of passenger body is placed out of a vehicle window, etc. belong to dangerous motions. According to the dangerous motion detection, a digital person can be controlled to output “keep your body inside the vehicle”, “please watch ahead”, or other voices, expressions, or motions.

In the embodiments of the present disclosure, the digital person can perform chat interaction with the person in the vehicle through voices, or interact with the person in the vehicle through expressions, or provide companion for the person in the vehicle through some preset actions.

In the above embodiment, by analyzing images in the video stream of the person in the vehicle, the task processing results of the predetermined task processing on the video stream are obtained. According to the task processing results, display or interaction feedback of a virtual digital person is automatically triggered, so that a human-computer interaction manner is more in line with human interaction habits, and an interaction process is more natural, which enables the person in the vehicle to feel the warmth of human-computer interaction, and enhances the riding pleasure, comfort and companion, and helps to reduce the driving safety risks.

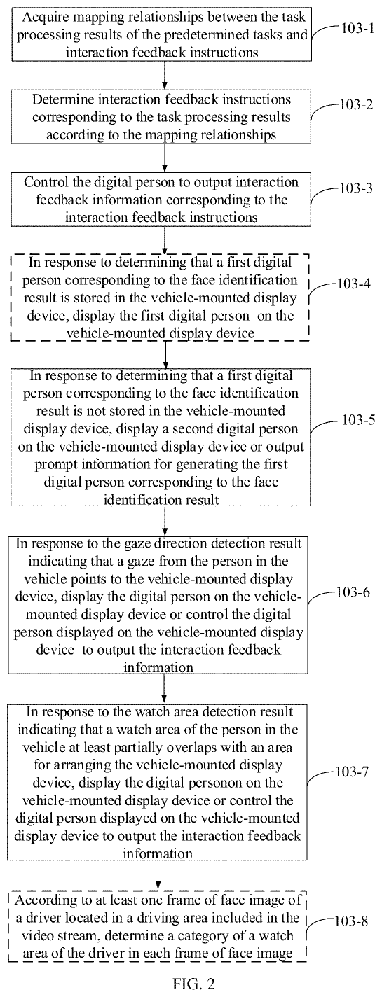

In some embodiments, the step 103, as shown in FIG. 2, includes following steps 103-1 to 103-3.

At step 103-1, mapping relationships between the task processing results of the predetermined tasks and interaction feedback instructions are acquired.

In the embodiments of the present disclosure, the digital person can acquire the mapping relationships between the task processing results of the predetermined tasks and the interaction feedback instructions pre-stored in a vehicle memory.

At step 103-2, interaction feedback instructions corresponding to the task processing results are determined according to the mapping relationships.

The digital person can determine interaction feedback instructions corresponding to different task processing results according to the mapping relationships.

At step 103-3, the digital person is controlled to output interaction feedback information corresponding to the interaction feedback instructions.

In an example, an interaction feedback instruction corresponding to the face detection result is a welcome instruction, and corresponding interaction feedback information is a welcome voice, expression, or motion.

In another example, an interaction feedback instruction corresponding to the gaze watch detection result or the watch area detection result is an instruction to display a digital person or an instruction to output a greeting. Correspondingly, the interaction feedback information can be “hello”, or other voices, expressions, or motions.

In another example, an interaction feedback instruction corresponding to the body detection result may be a prompt instruction to adjust sitting postures and body directions. The interaction feedback information can be “adjust sitting postures to sit comfortably”, or other voices, expressions, or motions.

In the above embodiment, the digital person can output the interaction feedback information corresponding to the interaction feedback instructions according to the acquired mapping relationships between the task processing results of the predetermined tasks and the interaction feedback instructions, so that in a closed vehicle space, a more humanized communication and interaction mode is provided, a communication interactivity is improved, a sense of trust from the person in the vehicle to drive the vehicle is increased, which thereby improves the driving pleasure and efficiency, reduces the safety risks, enables the person in the vehicle to be no longer lonely during their driving, and improves the artificial intelligence degree of the in-vehicle digital person.

In some embodiments, predetermined tasks include face identification, and accordingly, task processing results include a face identification result.

The step 103 may include step 103-4 or step 103-5.

At the step 103-4, in response to determining that a first digital person corresponding to the face identification result is stored in the vehicle-mounted display device, the first digital person is displayed on the vehicle-mounted display device.

In the embodiments of the present disclosure, the face identification result indicates that an identity of a person in the vehicle has been identified to be, for example, San ZHANG. If a first digital person corresponding to San ZHANG is stored in the vehicle-mounted display device, the first digital person can be directly displayed on the vehicle-mounted display device. For example, if the first digital person corresponding to San ZHANG is Avatar, the avatar can be displayed.

At step 103-5, in response to determining that a first digital person corresponding to the face identification result is not stored in the vehicle-mounted display device, a second digital person is displayed on the vehicle-mounted display device or prompt information for generating the first digital person corresponding to the face identification result is output.

In the embodiments of the present disclosure, if the first digital person corresponding to the face identification result is not stored in the vehicle-mounted display device, a second digital person set by default, such as a robot cat, can be displayed on the vehicle-mounted display device.

In the embodiments of the present disclosure, if the first digital person corresponding to the face identification result is not stored in the vehicle-mounted display device, the vehicle-mounted display device can output the prompt information for generating the first digital person corresponding to the face identification result. The person in the vehicle is prompted to set the first digital person through the prompt information.

In the above embodiment, according to the face identification result, the first digital person or the second digital person corresponding to the face identification result can be displayed, or the person in the vehicle is allowed to set the first digital person. This makes the images of the digital persons richer, and with the companion of the digital person set by the person in the vehicle during his/her driving, the loneliness is reduced and the driving pleasure is enhanced.

In some embodiments, the step 103-5 includes: outputting image capture prompt information of a face image on the vehicle-mounted display device.

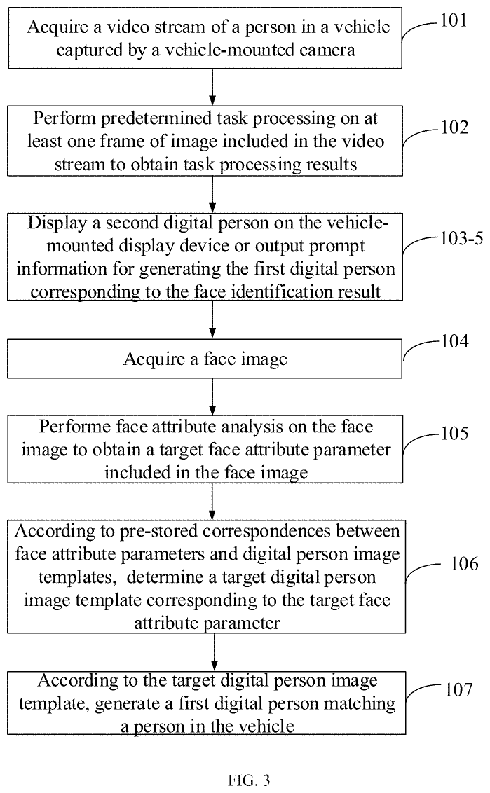

FIG. 3 is a flowchart illustrating an interaction method based on an in-vehicle digital person according to one or more embodiments of the present disclosure. As shown in FIG. 3, the interaction method includes the steps 101, 102, 103-5 and the following steps 104 to 107. For the steps 101, 102, 103-5, reference may be made to the relevant description in the above embodiments. The steps 104 to 107 will be described in detail below.

At step 104, a face image is acquired.

In the embodiments of the present disclosure, the face image may be a face image of a person in a vehicle captured by a vehicle-mounted camera in real time. Or, the face image may be a face image uploaded by a person in a vehicle through a terminal carried thereby.

At step 105, face attribute analysis is performed on the face image to obtain a target face attribute parameter included in the face image.

In the embodiments of the present disclosure, a face attribute analysis model can be pre-established, and the face attribute analysis model can use, but is not limited to, an ResNet (Residual Network) in a neural network. The neural network may include at least one convolutional layer, a BN (Batch Normalization) layer, a classification output layer, and the like.

A labeled sample image library can be input into the neural network to obtain a face attribute analysis result output from a classifier. Face attributes include, but are not limited to, facial features, a hairstyle, glasses, clothing, whether a hat is worn, etc. The face attribute analysis result can include multiple face attribute parameters, such as whether there is a beard, a beard position, whether glasses are worn, a glasses type, a glasses frame type, a lens shape, a glasses frame thickness, a hairstyle, an eyelid type (for example, a single eyelid, inner double eyelids or outer double eyelids), a clothing type, and whether there is a collar. Parameters of the neural network, such as parameters of the convolutional layer, the BN layer, and the classification output layer, or a learning rate of the entire neural network, or the like are adjusted according to the face attribute analysis result output from the neural network, so that the finally output face attribute analysis result and label contents in the sample image library conform to a preset fault tolerance difference, and are even consistent. Finally, training of the neural network is completed to obtain the face attribute analysis model.

In the embodiments of the present disclosure, at least one frame of image can be directly input to the face attribute analysis model to obtain a target face attribute parameter output from the face attribute analysis model.

At step 106, according to pre-stored correspondences between face attribute parameters and digital person image templates, a target digital person image template corresponding to the target face attribute parameter is determined.

In the embodiments of the present disclosure, correspondences between the face attribute parameters and the digital person image templates are pre-stored, so that corresponding target digital person image template can be determined according to the target face attribute parameter.

At step 107, according to the target digital person image template, a first digital person matching a person in the vehicle is generated.

In the embodiments of the present disclosure, the first digital person matching the person in the vehicle can be generated according to the determined target digital person image template. The target digital person image template can be directly used as the first digital person. The target digital person image template can be adjusted by the person in the vehicle, and the adjusted image template can be used as the first digital person.

In the above embodiment, the face image can be acquired based on the image capture prompt information output from the vehicle-mounted display device, and the face attribute analysis is performed on the face image, then the target digital person image template is determined, and thereby the first digital person matching the person in the vehicle is generated. Through the above process, a user in the vehicle is allowed to set the matched first digital person by himself/herself, and with the companion of the first digital person set by the user at DIY throughout his/her driving, the loneliness during the driving can be reduced and the image of the first digital person can be enriched.

In some embodiments, the step 107 may include step 107-1.

At the step 107-1, the target digital person image template is stored as the first digital person matching the person in the vehicle.

In the embodiments of the present disclosure, the target digital person image template can be directly stored as the first digital person matching the person in the vehicle.

In the above embodiment, the target digital person image template can be directly stored as the first digital person matching the person in the vehicle, which achieves the purpose of the person in the vehicle setting his/her liked first digital person at DIY.

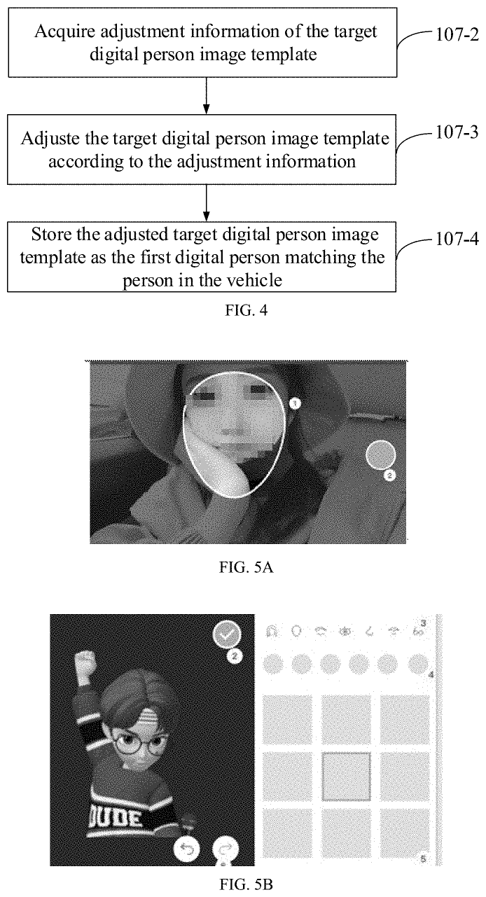

In some embodiments, the step 107, as shown in FIG. 4, may include steps 107-2, 107-3, and 107-4.

At the step 107-2, adjustment information of the target digital person image template is acquired.

In the embodiments of the present disclosure, after the target digital person image template is determined, adjustment information input by the person in the vehicle can be acquired. For example, if the hairstyle on the target digital person image template is short hair, the information is adjusted to be long curly hair, or if there are no glasses on the target digital person image template, the information is adjusted to add sunglasses.

At the step 107-3, the target digital person image template is adjusted according to the adjustment information.

For example, as shown in FIG. 5A, a face image is captured by a vehicle-mounted camera, and then a person in a vehicle can set a hairstyle, a face shape, facial features, etc. at DIY according to a generated target digital person image template. For example, as shown in FIG. 5B, at the step 107-4, the adjusted target digital person image template is stored as the first digital person matching the person in the vehicle.

In the embodiments of the present disclosure, the adjusted target digital person image template can be stored as the first digital person matching the person in the vehicle, and after the person in the vehicle is detected next time, the adjusted target digital person image template can be output.

In the above embodiment, the target digital person image template can be adjusted according to preferences of the person in the vehicle, and finally an adjusted first digital person that the person in the vehicle likes is obtained, so that the image of the first digital person is enriched, and the purpose of the person in the vehicle setting the first digital person at DIY is achieved.

In some embodiments, the step 104 may include any of the following steps 104-1 and 104-2.

At the step 104-1, a face image captured by the vehicle-mounted camera is acquired.

In the embodiments of the present disclosure, the face image can be directly captured by the vehicle-mounted camera in real time.

At the step 104-2, an uploaded face image is acquired.

In the embodiments of the present disclosure, the person in the vehicle can upload a face image that he/she likes, and the face image can be a face image corresponding to a face part of the person in the vehicle, or a face image corresponding to a person, an animal, or a cartoon image that the person in the vehicle likes.

In the above embodiment, the face image captured by the vehicle-mounted camera can be acquired, or the uploaded face image can be acquired, so that corresponding first digital person can be generated subsequently according to the face image, which is easy to implement, has high usability, and improves user experience.

In some embodiments, predetermined tasks include gaze detection, and accordingly, task processing results include a gaze direction detection result.

The step 103 may include step 103-6.

At the step 103-6, in response to the gaze direction detection result indicating that a gaze from the person in the vehicle points to the vehicle-mounted display device, the digital person is displayed on the vehicle-mounted display device or the digital person displayed on the vehicle-mounted display device is controlled to output the interaction feedback information. In some embodiments, in response to the gaze direction detection result indicating that a time period for which the gaze from the person in the vehicle points to the vehicle-mounted display device exceeds a preset time period, the digital person is displayed on the vehicle-mounted display device or the digital person displayed on the vehicle-mounted display device is controlled to output the interaction feedback information. The preset time period can be 0.5 s, which can be adjusted according to needs of the person in the vehicle.

In the embodiments of the present disclosure, a gaze direction detection model can be pre-established, and the gaze direction detection model can use a neural network, such as an ResNet (Residual Network), a googlenet, or a VGG (Visual Geometry Group Network). The neural network may include at least one convolutional layer, a BN (Batch Normalization) layer, a classification output layer, and the like.

A labeled sample image library can be input into the neural network to obtain a gaze direction analysis result output from a classifier. The gaze direction analysis result includes, but is not limited to, a direction of any vehicle-mounted device that a person in a vehicle is watching. The vehicle-mounted device includes a vehicle-mounted display device, a stereo, an air conditioner, and so on.

In the embodiments of the present disclosure, at least one frame of image can be input to the pre-established gaze direction detection model, and the gaze direction detection model outputs the result. If the gaze direction detection result indicates that the gaze from the person in the vehicle points to the vehicle-mounted display device, the digital person can be displayed on the vehicle-mounted display device.

For example, after a person enters a vehicle, corresponding digital person can be called by watching. As shown in FIG. 5B, the digital person is pre-set according to a face image of the person.

Or, when the gaze direction detection result indicates that the gaze from the person in the vehicle points to the vehicle-mounted display device, the digital person displayed on the vehicle-mounted display device can be controlled to output the interaction feedback information.

For example, a digital person is controlled to greet a person in a vehicle through at least one of voices, expressions, or motions.

In some embodiments, predetermined tasks include watch area detection, and accordingly, task processing results include a watch area detection result.

The step 103 includes step 103-7.

At the step 103-7, in response to the watch area detection result indicating that a watch area of the person in the vehicle at least partially overlaps with an area for arranging the vehicle-mounted display device, the digital person is displayed on the vehicle-mounted display device or the digital person displayed on the vehicle-mounted display device is controlled to output the interaction feedback information.

In the embodiments of the present disclosure, a neural network can be pre-established, and the neural network can analyze the watch areas to obtain the watch area detection result. In response to the watch area detection result indicating that the watch area of the person in the vehicle at least partially overlaps with the area for arranging the vehicle-mounted display device, the digital person can be displayed on the vehicle-mounted display device. That is, the digital person can be activated by detecting the watch area of the person in the vehicle.

Or, the digital person displayed on the vehicle-mounted display device can be controlled to output the interaction feedback information. For example, a digital person is controlled to greet a person in a vehicle through at least one of voices, expressions, or motions.

In the above embodiment, the person in the vehicle can activate the digital person, or allow the digital person to output the interaction feedback information by turning their gazes to the vehicle-mounted display device, and by detecting their gaze directions or watch areas, which improves the artificial intelligence degree of the in-vehicle digital person.

In some embodiments, the person in the vehicle includes a driver, and the step 103 may include: performing watch area detection processing on the at least one frame of image included in the video stream to obtain the watch area detection result. In this case, the step 103 includes step 103-8.

At the step 103-8, according to at least one frame of face image of a driver located in a driving area included in the video stream, a category of a watch area of the driver in each frame of face image is determined, where the watch area in each frame of face image belongs to one of multiple categories of defined watch areas obtained by pre-dividing space areas of the vehicle.

In the embodiments of the present disclosure, the face image of the driver can include an entire head part of the driver, or a facial contour and facial features of the driver. Any frame of image in the video stream can be used as the face image of the driver, or a face area image of the driver can be detected from any frame of image in the video stream, and the face area image is used as the face image of the driver. The above manner for detecting the face area image of the driver can be any face detection algorithm, which is not specifically limited in the present disclosure.

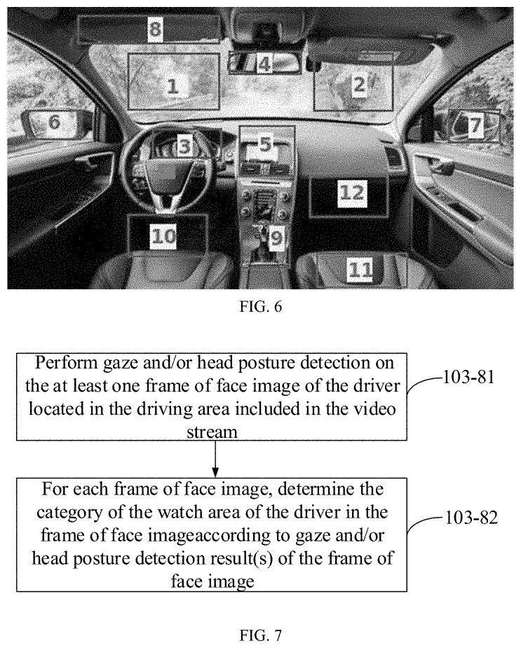

In the embodiments of the present disclosure, by dividing indoor space and/or outdoor space of the vehicle into multiple different areas, different categories of watch areas are obtained. For example, FIG. 6 is a manner for dividing categories of watch areas provided in the present disclosure. As shown in FIG. 6, multiple categories of watch areas obtained by pre-dividing space areas of a vehicle include two or more categories of a left front windshield area (watch area No. 1), a right front windshield area (watch area No. 2), a dashboard area (watch area No. 3), an interior rearview mirror area (watch area No. 4), a center console area (watch area No. 5), a left rearview mirror area (watch area No. 6), a right rearview mirror area (watch area No. 7), a visor area (watch area No. 8), a shift lever area (watch area No. 9), an area below a steering wheel (watch area No. 10), a co-driver area (watch area No. 11), and a glove compartment area in front of a co-driver (watch area No. 12), where the center console area (watch area No. 5) can be reused as a vehicle-mounted display area.

Using this manner for dividing the space areas of the vehicle, it is beneficial to perform targeted analysis on attention of the driver. According to the manner for dividing the space areas, various areas where the attention of the driver may fall when the driver is in a driving state are fully considered, which is beneficial to comprehensively analyze the attention of the driver in forward space of the vehicle, thereby improving the accuracy and precision of the analysis on the attention of the driver.

It should be understood that because space distribution of vehicles with different vehicle models are different, categories of watch areas can be divided according to the vehicle models. For example, a driving cab in FIG. 6 is on a left side in a vehicle. During normal driving, gazes from a driver are in a left front windshield area for most of his/her time. With regard to vehicle models having a driving cab on a right side in a vehicle, during normal driving, gazes from a driver are in a right front windshield area for most of his/her time. Obviously, the division of categories of watch areas can be different from that in FIG. 6. In addition, the categories of watch areas can be divided according to personal preference of a person in a vehicle. For example, a person in a vehicle believes that a screen area of a center console is too small and prefers to use a terminal with a larger screen area to control an air conditioner, a stereo, and other vehicle-mounted devices. At this time, a center console area in watch areas can be adjusted according to a position for arranging the terminal. The categories of the watch areas can be divided in other manners according to specific conditions, and the present disclosure does not limit the manner for dividing the categories of the watch areas.

Eyes are main sense organs for a driver to acquire road condition information, and areas where gazes from the driver are located largely reflect attention conditions of the driver. By performing processing on at least one frame of face image of a driver located in a driving area included in a video stream, a category of a watch area of the driver in each frame of face image can be determined, and therefore, analysis on attention of the driver can be implemented. In some possible implementation manners, processing is performed on a face image of a driver to obtain a gaze direction of the driver in the face image, and a category of a watch area of the driver in the face image is determined according to preset mapping relationships between gaze directions and categories of watch areas. In other possible implementation manners, feature extraction processing is performed on a face image of a driver, and a category of a watch area of the driver in the face image is determined according to extracted features. In some embodiments, category identification information of a watch area of a driver may be a predetermined number corresponding to each watch area.

In some embodiments, the step 103-8, as shown in FIG. 7, may include steps 103-81 and 103-82.

At the step 103-81, gaze and/or head posture detection is performed on the at least one frame of face image of the driver located in the driving area included in the video stream.

In the embodiments of the present disclosure, the gaze and/or head posture detection includes: gaze detection; head posture detection; gaze detection and head posture detection.

Gaze information and/or head posture information can be obtained by performing the gaze detection and the head posture detection on the face image of the driver through a pre-trained neural network, where the gaze information includes gazes, and starting positions of the gazes. In a possible implementation manner, gaze information and/or head posture information are obtained by sequentially performing convolution processing, normalization processing, and linear transformation on face images of a driver.

Driver face confirmation, eye area confirmation, and iris center confirmation are performed sequentially on face images of a driver to implement gaze detection and determine gaze information. In some possible implementation manners, an eye contour of a person when looking horizontally or upwards is larger than that when looking downwards. Therefore, first, according to pre-measured sizes of eye rims, looking downwards can be distinguished from looking horizontally and upwards. Then, using different ratios of distances from an upper eye rim to an eye center when looking upwards and horizontally, looking upwards can be distinguished from looking horizontally. Next, problems of looking left, forward and right can be dealt with. All ratios of a sum of squares of distances from a pupil point to a left eye rim to a sum of squares of distances from a pupil point to a right eye rim can be calculated, and gaze information when looking left, forward and right can be determined according to the ratios.

Head postures of a driver can be determined by performing processing on face images of the driver. In some possible implementation manners, facial feature points (such as a mouth, a nose, and eyes) can be extracted from face images of a driver, and positions of the facial feature points in the face images can be determined based on the extracted facial feature points, then a head posture of the driver in the face images can be determined according to relative positions between the facial feature points and a head part.

In addition, gazes and head postures can be detected at the same time to improve detection accuracy. In some possible implementation manners, a sequence of images of eye movements is captured by a camera deployed on a vehicle. The sequence of images is compared with an eye image when looking forwards. A rotation angle of an eyeball is obtained according to a compared difference, and a gaze vector is determined based on the rotation angle of the eyeball. Here, the detection result is obtained in a case of assuming that a head part does not move. When the head part rotates slightly, a coordinate compensation mechanism is first established to adjust the eye image when looking forwards. However, when the head part rotates greatly, changing positions and directions of the head part relative to a fixed coordinate system in space are first observed, and then a gaze vector is determined.

It can be understood that the above are examples of the gaze and/or head posture detection provided by the embodiments of the present disclosure. In specific implementation, those skilled in the art may perform gaze and/or head posture detection in other manners, which are not limited in the present disclosure.

At the step 103-82, for each frame of face image, the category of the watch area of the driver in the frame of face image is determined according to gaze and/or head posture detection result(s) of the frame of face image.

In the embodiments of the present disclosure, a gaze detection result includes a gaze vector of a driver and a starting position of the gaze vector in each frame of face image, and a head posture detection result includes a head posture of a driver in each frame of face image, where the gaze vector can be understood as a gaze direction. According to the gaze vector, a deviation angle of a gaze from the driver in the face image relative to a gaze from the driver when looking forwards can be determined. The head posture can be an Euler angle of a head part of the driver in a coordinate system, where the coordinate system may be a world coordinate system, a camera coordinate system, an image coordinate system, or the like.

By training a watch area classification model through a training set, the trained watch area classification model can determine a category of a watch area of a driver according to gaze and/or head posture detection result(s), where face images in the training set include the gaze and/or head posture detection result(s), and watch area category label information corresponding to the gaze and/or head posture detection result(s). The watch area classification model may include a decision tree classification model, a selection tree classification model, a softmax classification model, or the like. In some possible implementation manners, both a gaze detection result and a head posture detection result are feature vectors. Fusion processing is performed on the gaze detection result and the head posture detection result, and the watch area classification model determines a category of a watch area of a driver according to fused features. In an embodiment, fusion processing may be feature stitching. In other possible implementation manners, a watch area classification model can determine a category of a watch area of a driver based on a gaze detection result or a head posture detection result.

Environments in vehicles with different vehicle models and manners for dividing categories of watch areas may be different. In some embodiments, a classifier for classifying watch areas is trained using a training set corresponding to a vehicle model, so that the trained classifier can be applied to different vehicle models, where face images in a training set corresponding to a new vehicle model include watch area category label information of corresponding new vehicle model, and gaze and/or head posture detection result(s) corresponding to the watch area category label information of the new vehicle model, and a classifier that needs to be used in the new vehicle model is supervised and trained based on the training set. The classifier can be pre-built based on a neural network, a support vector machine, etc. The present disclosure does not limit the specific structure of the classifier.

In some possible implementation manners, for vehicle model A, forward space of a driver is divided into 12 watch areas; for vehicle model B, forward space of a driver can be divided into 10 watch areas according to vehicle space features of the vehicle model B. In this case, if an attention analysis scheme of the driver constructed based on the vehicle model A is applied to the vehicle model B, before the attention analysis scheme of the driver constructed based on the vehicle model A is applied to the vehicle model B, gaze and/or head posture detection technologies in the vehicle model A can be reused. For the space features of the vehicle model B, watch areas are re-divided. A training set for the vehicle model B is constructed based on the gaze and/or head posture detection technologies and watch areas corresponding to the vehicle model B. Face images in the training set for the vehicle model B include gaze and/or head posture detection result(s), and its corresponding watch area category label information of the vehicle model B. In this way, based on the constructed training set for the vehicle model B, a classifier for classifying watch areas of the vehicle model B is supervised and trained. There is no need to repeatedly train a model for gaze and/or head posture detection. The trained classifier and the reused gaze and/or head posture detection technologies constitute the attention analysis scheme of the driver that can be applied to the vehicle model B.

In some embodiments, feature information detection (such as gaze and/or head posture detection) required for watch area classification, and the watch area classification based on feature information are performed in two relatively independent stages, which improves the reusability of gaze and/or head posture or other feature information detection technologies in different vehicle models. Since, in new application scenarios where the division of watch areas changes (such as new vehicle models), only a classifier or a classification method for dividing new watch areas needs to be adjusted correspondingly, the complexity and the computation amount of adjusting the attention analysis scheme of the driver are reduced in the new application scenarios where the division of watch areas changes, the universality and the generalization of the technical solutions are improved, and further the diversified practical application requirements are better met.

In addition to the feature information detection required for watch area classification, and the watch area classification based on feature information that are performed in two relatively independent stages, the embodiments of the present disclosure can implement end-to-end detection of categories of watch areas based on a neural network, that is, a face image is input to the neural network, and after the face image is processed through the neural network, a watch area category detection result is output, where the neural network may be stacked or composed in a certain manner based on network units such as a convolutional layer, a nonlinear layer, and fully connected layers, or may adopt an existing neural network structure, which is not limited in the present disclosure. After a neural network structure to be trained is determined, the neural network may be supervised and trained using a face image set for, or the neural network may be supervised and trained using a face image set and based on eye images intercepted from each face image in the face image set. Each face image in the face image set includes watch area category label information in the face image, and the watch area category label information in the face image indicates one of the multiple categories of defined watch areas. Supervising and training the neural network based on the face image set enable the neural network to simultaneously learn the feature extraction capability required for watch area category division and the watch area classification capability, thereby implementing end-to-end detection of inputting the image and outputting the watch area category detection result.

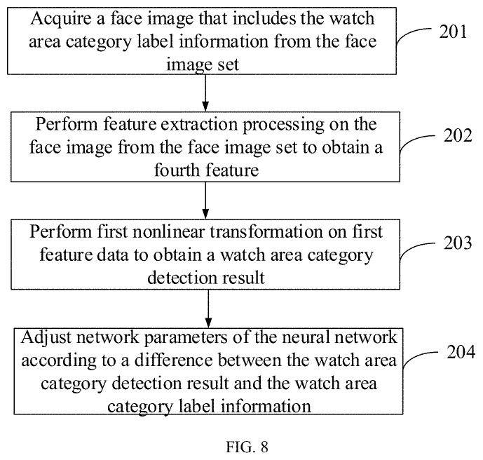

In some embodiments, for example, as shown in FIG. 8, it is a schematic flowchart illustrating a method for training a neural network for detecting a watch area category according to an embodiment of the present disclosure.

At step 201, a face image that includes the watch area category label information is acquired from the face image set.

In this embodiment, each frame of face image in the face image set includes the watch area category label information. Taking the watch area category division in FIG. 6 as an example, label information included in each frame of face image is any number from 1 to 12.

At step 202, feature extraction processing is performed on the face image from the face image set to obtain a fourth feature.

The feature extraction processing can be performed on the face image through a neural network to obtain the fourth feature. In some possible implementation manners, feature extraction processing is implemented by sequentially performing convolution processing, normalization processing, first linear transformation, and second linear transformation on face images to obtain a fourth feature.

First, convolution processing is performed on face images through multiple convolutional layers in a neural network to obtain a fifth feature, where feature contents and semantic information extracted through each convolutional layer are different, which is specifically embodied in: extracting image features step by step through the convolution processing of the multiple convolutional layers, while removing relatively secondary features gradually. Therefore, the smaller the feature sizes extracted later are, the more concentrated the contents and semantic information are. Convolution operation is performed on face images step by step through multiple convolutional layers, and corresponding intermediate features are extracted to finally obtain feature data with a fixed size. In this way, while main content information of the face images (that is, feature data of the face images) is obtained, image sizes can be reduced, a system computation amount can be decreased, and a computation speed can be increased. The implementation process of the convolution processing is as follows: performing convolution processing on face images through convolutional layers, that is, sliding on the face images with a convolution kernel, and multiplying a pixel value on a face image point with a numerical value on corresponding convolution kernel, then adding all the multiplied values as a pixel value on the image corresponding to an intermediate pixel of the convolution kernel, finally, after performing sliding processing on all pixel values in the face image, extracting a fifth feature. It should be understood that the present disclosure does not specifically limit the number of convolutional layers.

When convolution processing is performed on face images, after data is processed through each layer of network, data distribution will change, which will bring difficulties to extraction through next layer of network. Therefore, before subsequent processing is performed on the fifth feature obtained through the convolution processing, normalization processing needs to be performed on the fifth feature, that is, the fifth feature is normalized to normal distribution with an average value of 0 and a variance of 1. In some possible implementation manners, a BN layer for normalization is connected behind convolutional layers, and features are normalized through the BN layer by adding trainable parameters, which can speed up the training, remove the data correlation, and highlight the feature distribution differences. In an example, for the processing on the fifth feature through the BN layer, reference may be made to the following description:

Assuming a fifth feature is β=x_{1→m}, including m pieces of data in total, the BN layer will perform the following operations on the fifth feature:

First, an average value of the fifth feature β=x_{1→m} is calculated, that is,

$${μ}_{B} = \frac{1}{m} {\sum }_{i = 1}^{m} {x}_{i} .$$

According to the average value, μ_{β}, a variance of the fifth feature is determined, that is,

$${σ}_{β}^{2} = \frac{1}{m} {\sum }_{i = 1} {m ( {x}_{i} - {μ}_{β} )}^{2} .$$

According to the average value, μ_{β} and the variance σ_{β}², normalization processing is performed on the fifth feature to obtain xᵢ⁻.

Finally, based on a scaling variable γ and a translation variable δ, a normalization result is obtained, that is, yᵢ=γxᵢ⁻+δ, where both γ and δ are known.

Due to the smaller abilities of convolution processing and normalization processing to learn complex mappings from data, complex types of data, such as images, videos, audios, or voices cannot be learned and processed. Therefore, there is a need to solve complex problems such as image processing and video processing by linearly transforming normalized data. A linear activation function is connected behind the BN layer, and linear transformation is performed on normalized data through the activation function, so that complex mappings can be processed. In some possible implementation manners, the normalized data is substituted into a rectified linear unit (ReLU) to realize first linear transformation on the normalized data to obtain a sixth feature.

Fully connected (FC) layers are connected behind an activation function layer. The sixth feature is processed through the fully connected layers, and the sixth feature can be mapped to sample (that is, watch area) label space. In some possible implementation manners, second linear transformation is performed on the sixth feature through the fully connected layers. The fully connected layers include an input layer (that is, the activation function layer) and an output layer. Any neuron in the output layer is connected to each neuron in the input layer. Each neuron in the output layer has corresponding weight and bias. Therefore, all parameters in the fully connected layers are the weight and the bias of each neuron. The specific weight and bias are obtained by training the fully connected layers.

When the sixth feature is input to the fully connected layers, weights and biases of the fully connected layers (that is, a weight of second feature data) are obtained, and then weighted summation is performed on the sixth feature according to the weights and the biases to obtain the fourth feature. In some possible implementation manners, the weights and the biases of the fully connected layers are: wᵢ and bᵢ, where i is the number of neurons, and the sixth feature is x, then first feature data obtained by performing the second linear transformation on third feature data through the fully connected layers is

$${{\sum }_{i = 1}}^{i} ( {w}_{i} x + {b}_{i} ) .$$

At step 203, first nonlinear transformation is performed on first feature data to obtain a watch area category detection result.

A softmax layer is connected behind the fully connected layers. Different input feature data is mapped to values between 0 and 1 through a softmax function built in the softmax layer, and a sum of all mapped values is 1. The mapped values correspond to the input features one to one. In this way, it is equivalent to completing the prediction for each piece of feature data, and giving corresponding probability in the form of numerical value. In a possible implementation manner, a fourth feature is input to the softmax layer, and the fourth feature is substituted into the softmax function, so that the first nonlinear transformation can be performed thereon to obtain the probabilities that gazes from a driver are in different watch areas.

At step 204, network parameters of the neural network are adjusted according to a difference between the watch area category detection result and the watch area category label information.

In this embodiment, the neural network includes a loss function, and the loss function may be: a cross entropy loss function, a mean square error loss function, a square loss function, or the like. The present disclosure does not limit the specific form of the loss function.

Each face image in a face image set has corresponding label information, that is, each face image corresponds to one watch area category, and the probabilities in different watch areas obtained in the step 202 and the label information are substituted into the loss function to obtain a loss function value. By adjusting the network parameters of the neural network, the loss function value is allowed to be less than or equal to a preset threshold to complete the training of the neural network. The network parameters include the weight and bias of each network layer in the steps 201 and 202.

In this embodiment, the neural network is trained according to the face image set that includes the watch area category label information, so that the trained neural network can determine the watch area category based on the extracted features of the face image. Based on the training method provided in this embodiment, only the face image set needs to be input to obtain the trained neural network. This training method is simple and the training time is short.

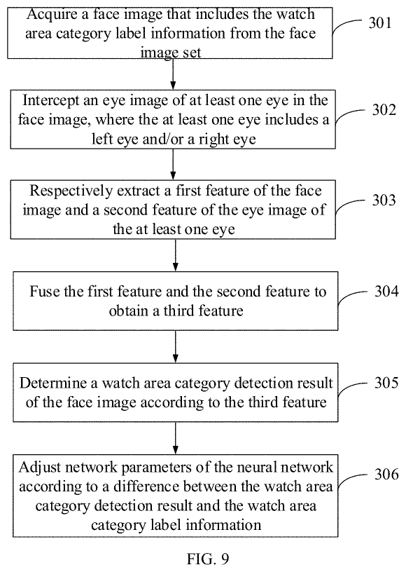

In some embodiments, for example, FIG. 9 is a schematic flowchart illustrating a method for training a neural network according to another embodiment of the present disclosure.

At step 301, a face image that includes the watch area category label information is acquired from the face image set.

In this embodiment, each frame of face image in the face image set includes the watch area category label information. Taking the watch area category division in FIG. 6 as an example, label information included in each frame of face image is any number from 1 to 12.

By fusing features with different scales to enrich feature information, the accuracy of watch area category detection can be improved. For the implementation process of enriching the feature information, reference may be made to steps 302 to 305.

At step 302, an eye image of at least one eye in the face image is intercepted, where the at least one eye includes a left eye and/or a right eye.

In this embodiment, an eye area image can be identified from the face image, and the eye area image can be intercepted from the face image through screenshot software or drawing software. The present disclosure does not limit the specific implementation manners for how to identify the eye area image from the face image and how to intercept the eye area image from the face image.

At step 303, a first feature of the face image and a second feature of the eye image of the at least one eye are respectively extracted.

In this embodiment, the trained neural network includes multiple feature extraction branches. Second feature extraction processing is performed on the face image and the eye image through different feature extraction branches to obtain the first feature of the face image and the second feature of the eye image, which enriches the extracted image feature scales. In some possible implementation manners, convolution processing, normalization processing, third linear transformation, and fourth linear transformation are sequentially performed on the face image through different feature extraction branches to obtain the first feature and the second feature, where gaze vector information includes a gaze vector, and a starting position of the gaze vector. It should be understood that the eye image can include only one eye (a left eye or a right eye), or two eyes, which is not limited in the present disclosure.

For the specific implementation process of the convolution processing, the normalization processing, the third linear transformation, and the fourth linear transformation, reference may be made to the convolution processing, the normalization processing, the first linear transformation, and the second linear transformation in the step 202, which will not be repeat herein.

At step 304, the first feature and the second feature are fused to obtain a third feature.

Since features of the same object (the driver in this embodiment) with different scales include different scenario information, by fusing the features with different scales, more informative features can be obtained.

In some possible implementation manners, by fusing the first feature and the second feature, feature information of multiple features is fused into one feature, which is beneficial to improve the detection accuracy of a watch area category of a driver.

At step 305, a watch area category detection result of the face image is determined according to the third feature.

In this embodiment, the watch area category detection result is probabilities that gazes from the driver are in different watch areas, and a value range is 0 to 1. In some possible implementation manners, the third feature is input to the softmax layer, and the third feature is substituted into the softmax function, so that the second nonlinear transformation can be performed thereon to obtain the probabilities that gazes from the driver are in different watch areas.

At step 306, network parameters of the neural network are adjusted according to a difference between the watch area category detection result and the watch area category label information.

In this embodiment, the neural network includes a loss function, and the loss function may be: a cross entropy loss function, a mean square error loss function, a square loss function, or the like. The present disclosure does not limit the specific form of the loss function.

The probabilities in different watch areas obtained in the step 305 and the label information are substituted into the loss function to obtain a loss function value. By adjusting the network parameters of the neural network, the loss function value is allowed to be less than or equal to a preset threshold to complete the training of the neural network. The network parameters include the weight and bias of each network layer in the steps 303 to 305.

Through the neural network trained by the training method provided in this embodiment, features with different scales extracted from the same frame of image can be fused, which enriches feature information, and then the watch area category of the driver can be identified based on the fused features to improve the identification accuracy.

Those skilled in the art should understand that the two methods for training the neural network (steps 201 to 204 and steps 301 to 306) provided in the present disclosure can be implemented on a local terminal (such as a computer or a mobile phone), or through a cloud (such as a server), which is not limited in the present disclosure.

In some embodiments, for example, as shown in FIG. 10, the interaction method may further include steps 108 and 109.

At the step 108, vehicle control instructions corresponding to the interaction feedback information are generated.

In the embodiments of the present disclosure, the vehicle control instructions corresponding to the interaction feedback information output by the digital person can be generated.

For example, if interaction feedback information output by a digital person is “let me play a song for you”, a vehicle control instruction can be to control a vehicle-mounted audio player device to play audio.

At the step 109, target vehicle-mounted devices corresponding to the vehicle control instructions are controlled to perform operations indicated by the vehicle control instructions.

In the embodiments of the present disclosure, corresponding target vehicle-mounted devices can be controlled to perform the operations indicated by the vehicle control instructions.

For example, if a vehicle control instruction is to open windows, the windows can be controlled to lower. For another example, if a vehicle control instruction is to turn off a radio, the radio can be controlled to turn off.

In the above embodiment, in addition to outputting the interaction feedback information, the digital person can generate the vehicle control instructions corresponding to the interaction feedback information, thereby controlling corresponding target vehicle-mounted devices to perform corresponding operations, and allowing the digital person to become a warm link between the person and the vehicle.

In some embodiments, the interaction feedback information includes information contents for alleviating fatigue or distraction degree of the person in the vehicle, and the step 108 may include at least one of the following step 108-1 or 108-2.

At the step 108-1, a first vehicle control instruction that triggers a target vehicle-mounted device is generated.

The target vehicle-mounted device includes a vehicle-mounted device that alleviates the fatigue or distraction degree of the person in the vehicle through at least one of taste, smell, or hearing.

For example, interaction feedback information includes contents “I guess you are tired, and let's relax”. At this time, the fatigue degree of a person in a vehicle is determined to be severe, and a first vehicle control instruction to activate a seat massage can be generated. Or, interaction feedback information includes “don't be distracted”. At this time, the fatigue degree of a person in a vehicle is determined to be slight, and a first vehicle control instruction to start audio play can be generated. Or, interaction feedback information includes “Some distractions, and I guess you are a little tired”. The fatigue degree can be determined to be moderate. At this time, a first vehicle control instruction to turn on a fragrance system can be generated.

At the step 108-2, a second vehicle control instruction that triggers driver assistance is generated.

In the embodiments of the present disclosure, a second vehicle control instruction to assist the driver can be generated. For example, automatic driving is started to assist the driver in driving.

In the above embodiment, the first vehicle control instruction that triggers the target vehicle-mounted device and/or the second vehicle control instruction that triggers the driver assistance can be generated to improve the driving safety.

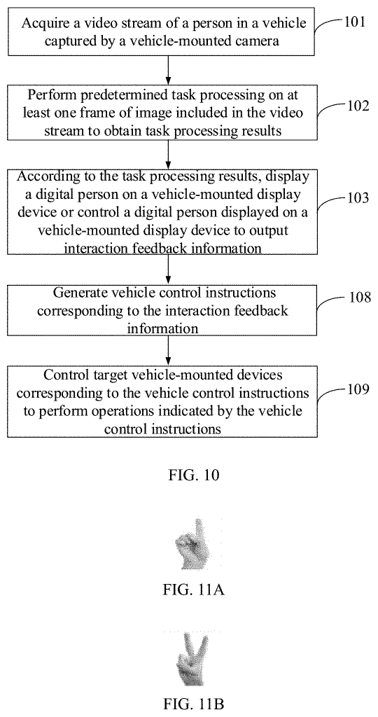

In some embodiments, the interaction feedback information includes confirmation contents for a gesture detection result, for example, a person in a vehicle inputs a thumb-up gesture, or a thumb-up and middle finger-up gesture. As shown in FIG. 11A and FIG. 11B, a digital person outputs interaction feedback information such as “OK” and “No problem”. The step 108 may include step 108-3.

At the step 108-3, according to mapping relationships between gestures and the vehicle control instructions, a vehicle control instruction corresponding to a gesture indicated by the gesture detection result is generated.

In the embodiments of the present disclosure, the mapping relationships between the gestures and the vehicle control instructions can be pre-stored to determine corresponding vehicle control instructions. For example, according to a mapping relationship, a vehicle control instruction corresponding to a thumb-up and middle finger-up gesture is that a vehicle-mounted processor receives images through Bluetooth. Or, only a vehicle control instruction corresponding to current gesture to capture an image by a vehicle-mounted camera is gesticulated.

In the above embodiment, according to the mapping relationships between the gestures and the vehicle control instructions, the vehicle control instruction corresponding to the gesture indicated by the gesture detection result is generated, and a person in a vehicle can control the vehicle more flexibly, so that a digital person can better become a warm link between the person in the vehicle and the vehicle.

In some embodiments, other vehicle-mounted devices can be controlled to turn on or off according to interaction information output by a digital person.

For example, if interaction information output by a digital person includes “let me open windows or an air conditioner for you”, the windows are controlled to open or the air conditioner is controlled to start. For another example, interaction information output by a digital person for a passenger includes “let's play a game”, a vehicle-mounted display device is controlled to display a game interface.

In the embodiments of the present disclosure, the digital person can be used as a warm link between the vehicle and the person in the vehicle, and accompany the person in the vehicle during his/her driving, which makes the digital person more humanized and becomes a more intelligent driving companion.

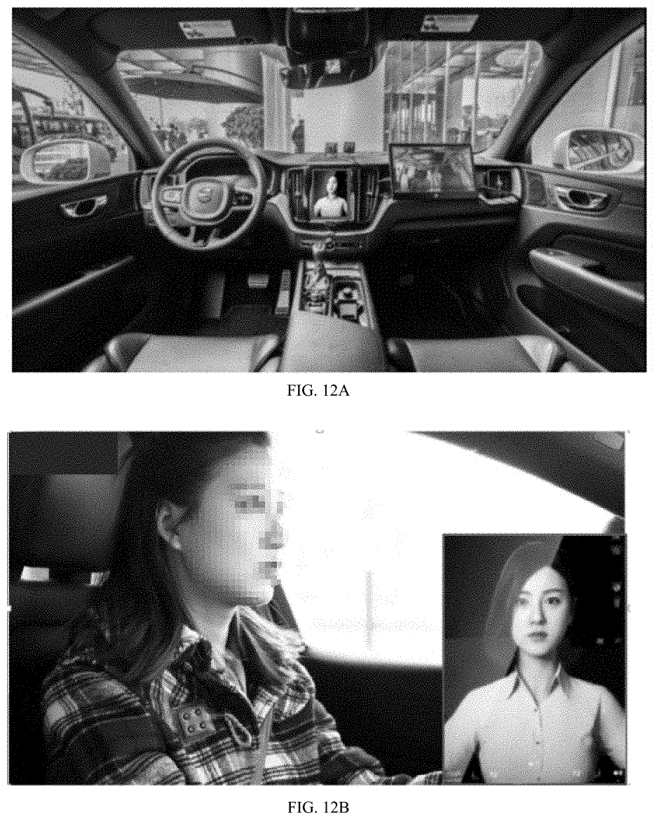

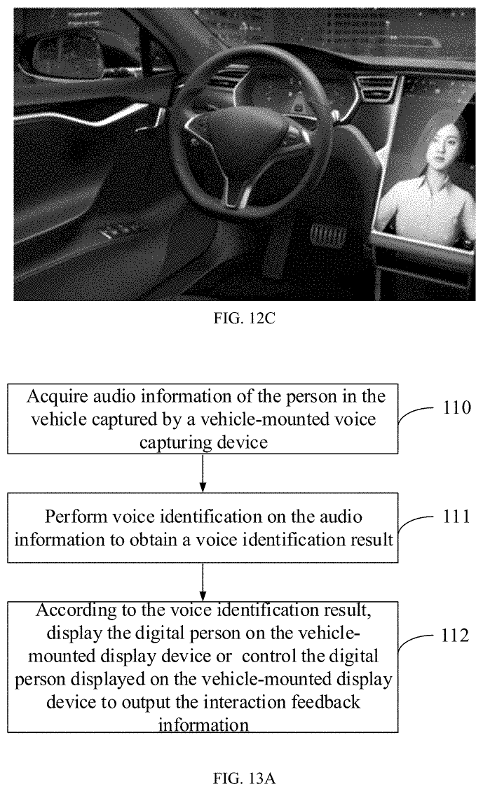

In the above embodiment, the video stream can be captured by the vehicle-mounted camera, and the predetermined task processing can be performed on at least one frame of image included in the video stream to obtain the task processing results. For example, face detection can be performed. After a face part is detected, gaze detection or watch area detection can be performed. When it is detected that gazes point to the vehicle-mounted display device or a watch area at least partially overlaps with an area for arranging a vehicle-mounted device, a digital person can be displayed on the vehicle-mounted display device. In some embodiments, face identification can be performed on at least one frame of image. If it is determined that there is a person in the vehicle, a digital person can be displayed on the vehicle-mounted display device, as shown in FIG. 12A.

Or, gaze detection or watch area detection can be performed on at least one frame of image to realize the process of activating a digital person through a gaze, as shown in FIG. 12B.

If the first digital person corresponding to the face identification result is not pre-stored, the second digital person can be displayed on the vehicle-mounted display device, or the prompt information can be output to allow the person in the vehicle to set the first digital person.

The first digital person can accompany the person in the vehicle during the entire driving, as shown in FIG. 12C, and interact with the person in the vehicle to output at least one of voice feedback information, expression feedback information, or motion feedback information.

Through the above process, the purpose of activating the digital person or controlling the digital person through gazes to output interaction feedback information and interact with the person in the vehicle is achieved. In the embodiments of the present disclosure, in addition to realizing the process through gazes, the digital person can be activated or controlled in many modes to output interactive feedback information.

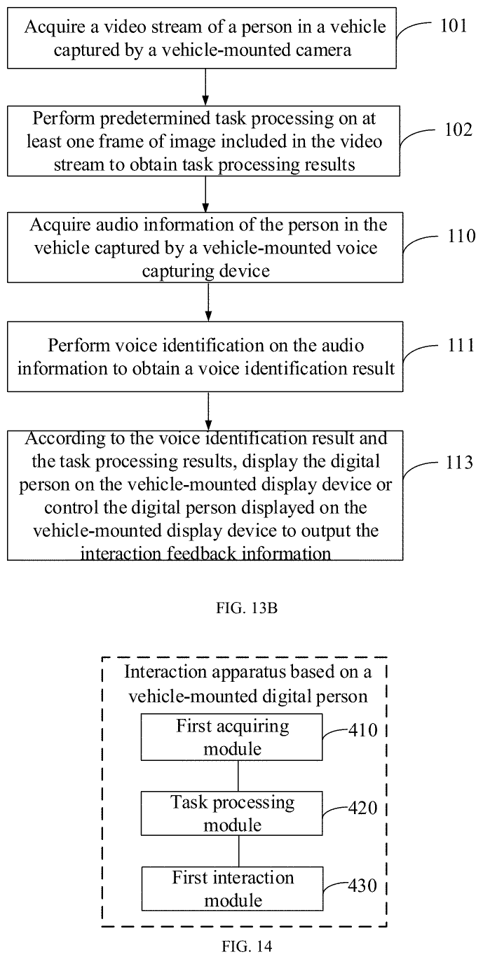

FIG. 13A is a flowchart illustrating an interaction method based on an in-vehicle digital person according to one or more embodiments of the present disclosure. As shown in FIG. 13A, the interaction method based on the in-vehicle digital person includes steps 110-112.

At step 110, audio information of the person in the vehicle captured by a vehicle-mounted voice capturing device is acquired.

In the embodiments of the present disclosure, the audio information of the person in the vehicle can be captured by the vehicle-mounted voice capturing device, such as a microphone.

At step 111, voice identification is performed on the audio information to obtain a voice identification result.

In the embodiments of the present disclosure, the voice identification can be performed on the audio information to obtain the voice identification result, and the voice identification result corresponds to different instructions.

At step 112, according to the voice identification result, the digital person is displayed on the vehicle-mounted display device or the digital person displayed on the vehicle-mounted display device is controlled to output the interaction feedback information.

In the embodiments of the present disclosure, the digital person can be activated by a person in the vehicle through voices, that is, the digital person can be displayed on the vehicle-mounted display device according to the voice identification result, or the digital person can be controlled according to the voices of the person in the vehicle to output interaction feedback information, and the interaction feedback information can include at least one of voice feedback information, expression feedback information, or motion feedback information.

For example, after a person in a vehicle enters a vehicle cabin and inputs a voice “activate digital person”, a digital person will be displayed on a vehicle-mounted display device according to the voice information. This digital person can be a first digital person preset by the person in the vehicle, or a second digital person set by default, or voice prompt information can be output to allow the person in the vehicle to set the first digital person.

For another example, a digital person displayed on a vehicle-mounted display device is controlled to chat with a person in a vehicle. If the person in the vehicle inputs a voice “it's hot today”, the digital person outputs interactive feedback information “do you need me to turn on the air conditioner for you” through at least one of voices, expressions, or motions.

In the above embodiment, in addition to activating or controlling the digital person through gazes to output interaction feedback information, the person in the vehicle can activate or control the digital person through voices to output the interaction feedback information, so that the interaction between the digital person and the person in the vehicle are more patterned, which enhances the intelligence degree of the digital person.

FIG. 13B is a flowchart illustrating an interaction method based on an in-vehicle digital person according to one or more embodiments of the present disclosure. As shown in FIG. 13B, the interaction method based on the in-vehicle digital person includes steps 101, 102, 110, 111, and 113.

For relevant description of the steps 101, 102, 110, and 111, reference may be made to the above embodiments, which will not be repeated herein.

At the step 113, according to the voice identification result and the task processing results, the digital person is displayed on the vehicle-mounted display device or the digital person displayed on the vehicle-mounted display device is controlled to output the interaction feedback information.

Corresponding to the above method embodiments, the present disclosure further provides apparatus embodiments.

FIG. 14 is a block diagram illustrating an interaction apparatus based on an in-vehicle digital person according to one or more embodiments of the present disclosure. The apparatus includes a first acquiring module 410 configured to acquire a video stream of a person in a vehicle captured by a vehicle-mounted camera; a task processing module 420 configured to perform predetermined task processing on at least one frame of image included in the video stream to obtain task processing results; a first interaction module 430 configured to, according to the task processing results, display a digital person on a vehicle-mounted display device or control a digital person displayed on a vehicle-mounted display device to output interaction feedback information.

In some embodiments, predetermined tasks include at least one of face detection, gaze detection, watch area detection, face identification, body detection, gesture detection, face attribute detection, emotional state detection, fatigue state detection, distracted state detection, or dangerous motion detection; and/or, the person in the vehicle includes at least one of a driver or a passenger; and/or, the interaction feedback information output by the digital person includes at least one of voice feedback information, expression feedback information, or motion feedback information.

In some embodiments, the first interaction module includes: a first acquiring submodule configured to acquire mapping relationships between the task processing results and interaction feedback instructions; a determining submodule configured to determine interaction feedback instructions corresponding to the task processing results according to the mapping relationships; and a control submodule configured to control the digital person to output interaction feedback information corresponding to the interaction feedback instructions.

In some embodiments, predetermined tasks include face identification; the task processing results include a face identification result; the first interaction module includes: a first display submodule configured to, in response to determining that a first digital person corresponding to the face identification result is stored in the vehicle-mounted display device, display the first digital person on the vehicle-mounted display device; or a second display submodule configured to, in response to determining that a first digital person corresponding to the face identification result is not stored in the vehicle-mounted display device, display a second digital person on the vehicle-mounted display device or output prompt information for generating the first digital person corresponding to the face identification result.

In some embodiments, the second display submodule includes: a display unit configured to output image capture prompt information of a face image on the vehicle-mounted display device; the apparatus further includes: a second acquiring module configured to acquire a face image; a face attribute analysis module configured to perform face attribute analysis on the face image to obtain a target face attribute parameter included in the face image; a template determining module configured to, according to pre-stored correspondences between face attribute parameters and digital person image templates, determine a target digital person image template corresponding to the target face attribute parameter; a digital person generating module configured to, according to the target digital person image template, generate a first digital person matching a person in the vehicle.

In some embodiments, the digital person generating module includes: a first storage submodule configured to store the target digital person image template as the first digital person matching the person in the vehicle.

In some embodiments, the digital person generating module includes: a second acquiring submodule configured to acquire adjustment information of the target digital person image template; an adjusting submodule configured to adjust the target digital person image template according to the adjustment information; and a second storage submodule configured to store the adjusted target digital person image template as the first digital person matching the person in the vehicle.

In some embodiments, the second acquiring module includes: a third acquiring submodule configured to acquire a face image captured by the vehicle-mounted camera; or a fourth acquiring submodule configured to acquire an uploaded face image.

In some embodiments, predetermined tasks include gaze detection; the task processing results include a gaze direction detection result; the first interaction module includes: a third display submodule configured to, in response to the gaze direction detection result indicating that gaze from the person in the vehicle point to the vehicle-mounted display device, display the digital person on the vehicle-mounted display device or control the digital person displayed on the vehicle-mounted display device to output the interaction feedback information.

In some embodiments, predetermined tasks include watch area detection; the task processing results include a watch area detection result; the first interaction module includes: a fourth display submodule configured to, in response to the watch area detection result indicating that a watch area of the person in the vehicle at least partially overlaps with an area for arranging the vehicle-mounted display device, display the digital person on the vehicle-mounted display device or control the digital person displayed on the vehicle-mounted display device to output the interaction feedback information.

In some embodiments, the person in the vehicle includes a driver; the first interaction module includes: a category determining submodule configured to, according to at least one frame of face image of a driver located in a driving area included in the video stream, determine a category of a watch area of the driver in each frame of face image, where the watch area in each frame of face image belongs to one of multiple categories of defined watch areas obtained by pre-dividing space areas of the vehicle.

In some embodiments, the multiple categories of defined watch areas obtained by pre-dividing the space areas of the vehicle include two or more categories of a left front windshield area, a right front windshield area, a dashboard area, an interior rearview mirror area, a center console area, a left rearview mirror area, a right rearview mirror area, a visor area, a shift lever area, an area below a steering wheel, a co-driver area, a glove compartment area in front of a co-driver, and a vehicle-mounted display area.

In some embodiments, the category determining submodule includes: a first detection unit configured to perform gaze and/or head posture detection on the at least one frame of face image of the driver located in the driving area included in the video stream; a category determining unit configured to, for each frame of face image, determine the category of the watch area of the driver in the frame of face image according to gaze and/or head posture detection result(s) of the frame of face image.

In some embodiments, the category determining submodule includes: an input unit configured to input the at least one frame of face image into a neural network, and output the category of the watch area of the driver in each frame of face image through the neural network, where the neural network is pre-trained using a face image set, each face image in the face image set includes watch area category label information in the face image, the watch area category label information in the face image indicates one of the multiple categories of defined watch areas, or the neural network is pre-trained using a face image set and based on eye images intercepted from each face image in the face image set.

In some embodiments, the apparatus further includes: a third acquiring module configured to acquire a face image that includes the watch area category label information from the face image set; an intercepting module configured to intercept an eye image of at least one eye in the face image, where the at least one eye includes a left eye and/or a right eye; a feature extraction module configured to respectively extract a first feature of the face image and a second feature of the eye image of the at least one eye; a fusing module configured to fuse the first feature and the second feature to obtain a third feature; a detection result determining module configured to determine a watch area category detection result of the face image according to the third feature; a parameter adjusting module configured to adjust network parameters of the neural network according to a difference between the watch area category detection result and the watch area category label information.

In some embodiments, the apparatus further includes: a vehicle control instruction generating module configured to generate vehicle control instructions corresponding to the interaction feedback information; a control module configured to control target vehicle-mounted devices corresponding to the vehicle control instructions to perform operations indicated by the vehicle control instructions.

In some embodiments, the interaction feedback information includes information contents for alleviating fatigue or distraction degree of the person in the vehicle; the vehicle control instruction generating module includes: a first generating submodule configured to generate a first vehicle control instruction that triggers a target vehicle-mounted device, where the target vehicle-mounted device includes a vehicle-mounted device that alleviates the fatigue or distraction degree of the person in the vehicle through at least one of taste, smell, or hearing; and/or a second generating submodule configured to generate a second vehicle control instruction that triggers driver assistance.

In some embodiments, the interaction feedback information includes confirmation contents for a gesture detection result; the vehicle control instruction generating module includes: a third generating submodule configured to, according to mapping relationships between gestures and the vehicle control instructions, generate a vehicle control instruction corresponding to a gesture indicated by the gesture detection result.

In some embodiments, the apparatus further includes: a fourth acquiring module configured to acquire audio information of the person in the vehicle captured by a vehicle-mounted voice capturing device; a voice identification module configured to perform voice identification on the audio information to obtain a voice identification result; a second interaction module configured to, according to the voice identification result and the task processing results, display the digital person on the vehicle-mounted display device or control the digital person displayed on the vehicle-mounted display device to output the interaction feedback information.

For the apparatus examples, since they basically correspond to the method examples, reference may be made to the partial description of the method examples. The apparatus examples described above are merely illustrative, where the units described as separate components may or may not be physically separated, and the components displayed as units may or may not be physical units, for example, may be located in one place or may be distributed to multiple network units. Some or all of the modules may be selected according to actual needs to achieve the objectives of the present disclosure. Those of ordinary skill in the art can understand and implement the present disclosure without any creative effort.

An embodiment of the present disclosure further provides a computer readable storage medium having a computer program stored thereon, where a processor is configured to, when executing the computer program, implement an interaction method based on an in-vehicle digital person as described in the above embodiments.

In some embodiments, the present disclosure further provides a computer program product, including: computer readable codes, where when the computer readable codes are running on a device, a processor in the device executes instructions for implementing an interaction method based on an in-vehicle digital person as provided in any of the above embodiments.

In some embodiments, the present disclosure further provides another computer program product for storing computer readable instructions, where when the instructions are executed, a computer is caused to perform operations in an interaction method based on an in-vehicle digital person as provided in any of the above embodiments.

The computer program product can be implemented specifically by hardware, software, or a combination thereof. In some embodiments, the computer program product is embodied specifically as a computer storage medium. In other embodiments, the computer program product is embodied specifically as a software product, such as a Software Development Kit (SDK).

An embodiment of the present disclosure further provides an interaction apparatus based on an in-vehicle digital person, including: a processor; a memory for storing processor executable instructions, where the processor is configured to, when calling the executable instructions stored in the memory, implement an interaction method based on an in-vehicle digital person according to any of the above embodiments.

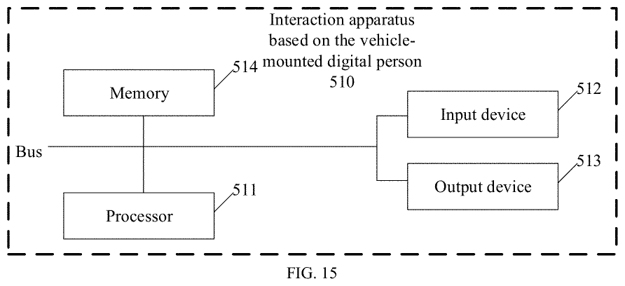

FIG. 15 is a schematic diagram illustrating a hardware structure of an interaction apparatus based on an in-vehicle digital person according to one or more embodiments of the present disclosure. The interaction apparatus based on the in-vehicle digital person 510 includes a processor 511, and may further include an input device 512, an output device 513 and a memory 514. The input device 512, the output device 513, the memory 514 and the processor 511 are connected to each other via a bus.

The memory includes, but is not limited to, a random access memory (RAM), a read-only memory (ROM), an erasable programmable read only memory (EPROM), or a compact disc read-only memory (CD-ROM), which is used for related instructions and data.

The input device is used to input data and/or signals, and the output device is used to output data and/or signals. The output device and the input device can be independent devices or an integrated device.

The processor may include one or more processors, for example, including one or more central processing unit (CPU). In a case where the processor is a CPU, the CPU may be a single-core CPU, or a multi-core CPU.

The memory is used to store program codes and data of network device.

The processor is used to call the program codes and data in the memory to execute the steps in the above method embodiments. For details, reference may be made to the description in the method embodiments, which will not be repeated here.

It can be understood that FIG. 15 only shows a simplified design of an interaction apparatus based on an in-vehicle digital person. In practical applications, the interaction apparatus based on the in-vehicle digital person may include other necessary components, including, but not limited to, any number of input/output devices, processors, controllers, memories, etc., and all elements that can implement the interaction solutions based on an in-vehicle digital person in the embodiments of the present disclosure are within the protection scope of the present disclosure.

Other embodiments of the present disclosure will be readily apparent to those skilled in the art after considering the specification and practicing the contents disclosed herein. The present application is intended to cover any variations, uses, or adaptations of the present disclosure, which follow the general principle of the present disclosure and include common knowledge or conventional technical means in the art that are not disclosed in the present disclosure. The specification and examples are to be regarded as illustrative only. The true scope and spirit of the present disclosure are pointed out by the following claims.

The above are only preferred embodiments of the present disclosure, and are not intended to limit the present disclosure. Any modification, equivalent replacement, improvement, etc. made within the spirit and principle of the present disclosure shall be included in the protection scope of the present disclosure.

1. An interaction method based on an in-vehicle digital person, comprising:
acquiring a video stream of a person in a vehicle captured by a vehicle-mounted camera;
processing, based on at least one predetermined task, at least one frame of image included in the video stream to obtain one or more task processing results; and
performing, according to the one or more task processing results, at least one of:
displaying a digital person on a vehicle-mounted display device or
controlling a digital person displayed on a vehicle-mounted display device to output interaction feedback information.

2. The interaction method of claim 1, wherein the at least one predetermined task comprises at least one of face detection, gaze detection, watch area detection, face identification, body detection, gesture detection, face attribute detection, emotional state detection, fatigue state detection, distracted state detection, or dangerous motion detection.

3. The interaction method of claim 1, wherein controlling the digital person displayed on the vehicle-mounted display device to output the interaction feedback information comprises:
acquiring mapping relationships between the task processing results and interaction feedback instructions;
determining the interaction feedback instructions corresponding to the task processing results according to the mapping relationships; and
controlling the digital person to output the interaction feedback information corresponding to the interaction feedback instructions.

4. The interaction method of claim 1, wherein the at least one predetermined task comprises face identification,
wherein the one or more task processing results comprise a face identification result, and
wherein displaying the digital person on the vehicle-mounted display device comprises one of:
in response to determining that a first digital person corresponding to the face identification result is stored in the vehicle-mounted display device, displaying the first digital person on the vehicle-mounted display device; or
in response to determining that a first digital person corresponding to the face identification result is not stored in the vehicle-mounted display device, displaying a second digital person on the vehicle-mounted display device or outputting prompt information for generating the first digital person corresponding to the face identification result.

5. The interaction method of claim 4, wherein outputting the prompt information for generating the first digital person corresponding to the face identification result comprises:
outputting image capture prompt information of a face image on the vehicle-mounted display device;
performing a face attribute analysis on a face image of the person in the vehicle, which is acquired by the vehicle-mounted camera in response to the image capture prompt information, to obtain a target face attribute parameter included in the face image;
determining a target digital person image template corresponding to the target face attribute parameter according to pre-stored correspondences between face attribute parameters and digital person image templates; and
generating the first digital person matching the person in the vehicle according to the target digital person image template.

6. The interaction method of claim 5, wherein generating the first digital person matching the person in the vehicle according to the target digital person image template comprises:
storing the target digital person image template as the first digital person matching the person in the vehicle.

7. The interaction method of claim 5, wherein generating the first digital person matching the person in the vehicle according to the target digital person image template comprises:
acquiring adjustment information of the target digital person image template;
adjusting the target digital person image template according to the adjustment information; and
storing the adjusted target digital person image template as the first digital person matching the person in the vehicle.

8. The interaction method of claim 1, wherein the at least one predetermined task comprises gaze detection,
wherein the one or more task processing results comprise a gaze direction detection result, and
wherein the interaction method comprises:
in response to the gaze direction detection result indicating that a gaze from the person in the vehicle points to the vehicle-mounted display device, performing at least one of:
displaying the digital person on the vehicle-mounted display device or
controlling the digital person displayed on the vehicle-mounted display device to output the interaction feedback information.

9. The interaction method of claim 1, wherein the at least one predetermined task comprises watch area detection,
wherein the one or more task processing results comprise a watch area detection result, and
wherein the interaction method comprises:
in response to the watch area detection result indicating that a watch area of the person in the vehicle at least partially overlaps with an area for arranging the vehicle-mounted display device, performing at least one of:
displaying the digital person on the vehicle-mounted display device or
controlling the digital person displayed on the vehicle-mounted display device to output the interaction feedback information.

10. The interaction method of claim 9 wherein the person in the vehicle comprises a driver, and
wherein processing, based on the at least one predetermined task, the at least one frame of image included in the video stream to obtain the one or more task processing results comprises:
according to at least one frame of face image of the driver located in a driving area included in the video stream, determining a category of a watch area of the driver in each of the at least one frame of face image of the driver.

11. The interaction method of claim 10, wherein the category of the watch area is obtained by pre-dividing space areas of the vehicle, and
wherein the category of the watch area comprises one of:
a left front windshield area, a right front windshield area, a dashboard area, an interior rearview mirror area, a center console area, a left rearview mirror area, a right rearview mirror area, a visor area, a shift lever area, an area below a steering wheel, a co-driver area, a glove compartment area in front of a co-driver, or a vehicle-mounted display area.

12. The interaction method of claim 10, wherein, according to the at least one frame of face image of the driver located in the driving area included in the video stream, determining the category of the watch area of the driver in each of the at least one frame of face image of the driver comprises:
for each of the at least one frame of face image of the driver,
performing at least one of gaze or head posture detection on the frame of face image of the driver; and
determining the category of the watch area of the driver in the frame of face image of the driver according to a result of the at least one of the gaze or the head posture detection of the frame of face image of the driver.

13. The interaction method of claim 10, wherein according to the at least one frame of face image of the driver located in the driving area included in the video stream, determining the category of the watch area of the driver in each of the at least one frame of face image of the driver comprises:
inputting the at least one frame of face image into a neural network to output the category of the watch area of the driver in each of the at least one frame of face image through the neural network,
wherein the neural network is pre-trained by one of:
using a face image set, each face image in the face image set comprising watch area category label information in the face image, the watch area category label information indicating the category of the watch area of the driver in the face image, or
using a face image set and being based on eye images intercepted from each face image in the face image set.

14. The interaction method of claim 13, wherein the neural network is pre-trained by:
for a face image including the watch area category label information from the face image set,
intercepting an eye image of at least one eye in the face image, wherein the at least one eye comprises at least one of a left eye or a right eye,
respectively extracting a first feature of the face image and a second feature of the eye image of the at least one eye,
fusing the first feature and the second feature to obtain a third feature,
determining a watch area category detection result of the face image according to the third feature by using the neural network, and
adjusting network parameters of the neural network according to a difference between the watch area category detection result and the watch area category label information.

15. The interaction method of claim 1, further comprising:
generating vehicle control instructions corresponding to the interaction feedback information; and
controlling target vehicle-mounted devices corresponding to the vehicle control instructions to perform operations indicated by the vehicle control instructions.

16. The interaction method of claim 15, wherein the interaction feedback information comprises information contents for alleviating a fatigue or distraction degree of the person in the vehicle, and
wherein generating the vehicle control instructions corresponding to the interaction feedback information comprises at least one of:
generating a first vehicle control instruction that triggers a target vehicle-mounted device, wherein the target vehicle-mounted device comprises a vehicle-mounted device that alleviates the fatigue or distraction degree of the person in the vehicle through at least one of taste, smell, or hearing; or
generating a second vehicle control instruction that triggers driver assistance.

17. The interaction method of claim 15, wherein the interaction feedback information comprises confirmation contents for a gesture detection result, and
wherein generating the vehicle control instructions corresponding to the interaction feedback information comprises:
according to mapping relationships between gestures and the vehicle control instructions, generating a vehicle control instruction corresponding to a gesture indicated by the gesture detection result.

18. The interaction method of claim 1, comprising:
acquiring audio information of the person in the vehicle captured by a vehicle-mounted voice capturing device;
performing voice identification on the audio information to obtain a voice identification result; and
according to the voice identification result and the one or more task processing results, performing the at least one of displaying the digital person on the vehicle-mounted display device or controlling the digital person displayed on the vehicle-mounted display device to output the interaction feedback information.

19. A non-transitory computer-readable storage medium coupled to at least one processor having machine-executable instructions stored thereon that, when executed by the at least one processor, cause the at least one processor to perform operations comprising:
acquiring a video stream of a person in a vehicle captured by a vehicle-mounted camera;
processing, based on at least one predetermined task, at least one frame of image included in the video stream to obtain one or more task processing results; and
performing, according to the one or more task processing results, at least one of
displaying a digital person on a vehicle-mounted display device or
controlling a digital person displayed on a vehicle-mounted display device to output interaction feedback information.

20. An interaction apparatus based on an in-vehicle digital person, comprising:
at least one processor; and
one or more memories coupled to the at least one processor and storing programming instructions for execution by the at least one processor to perform operations comprising:
acquiring a video stream of a person in a vehicle captured by a vehicle-mounted camera;
processing, based on at least one predetermined task, on at least one frame of image included in the video stream to obtain one or more task processing results; and
performing, according to the one or more task processing results, at least one of
displaying a digital person on a vehicle-mounted display device or
controlling a digital person displayed on a vehicle-mounted display device to output interaction feedback information.
